(19) United States
(12) Patent Application Publication
(10) Pub. No.: US 2023/0206295 A1
(43) Pub. Date: Jun. 29, 2023

(54) System and Method for On-Demand Laundry Services

(71) Applicant: Reyes Macias, Sylmar, CA (US)

(72) Inventor: Reyes Macias, Sylmar, CA (US)

(21) Appl. No.: 18/089,144

(22) Filed: Dec. 27, 2022

Related U.S. Application Data
(60) Provisional application No. 63/294,036, filed on Dec. 27, 2021.

(51) Int. Cl. G06Q 30/0601

(52) U.S. Cl. CPC G06Q 30/0605; G06Q 30/0627; G06Q 20/10

(57) ABSTRACT

A computer implemented system and method for providing user-based on-demand laundry services includes providing a peer-to-peer laundry service platform and configuring the platform to identify a plurality of client accounts and a plurality of service provider accounts. The platform detects when either a client account or a service provider account is selected, and detects a notice of availability by at least one service provider account for laundry services. After receiving a search query from the client account, which identifies a quantity of the laundry, the platform identifies one or more available service provider accounts and selects from among them a proximal service provider account. The search query is reported to the proximal service provider account, which sends an acceptance query. the platform detects a completion signal, and processes a payment from the client account to the proximal service provider account.

### CROSS-REFERENCES TO RELATED APPLICATIONS

This application claims the benefit of U.S. Provisional Patent Application No. 63/294,036, entitled “System and Process for Providing On-Demand Laundry Services Including Location-Based Pick-Up and Delivery Services,” filed Dec. 27, 2021, which is incorporated by reference herein in its entirety.

### FIELD OF THE INVENTION

This invention relates to laundry services, including wash and fold laundry services. More specifically the invention relates to a peer-to-peer on-demand laundry service computer application.

### BACKGROUND

Peer-to-peer networked and distributed applications are known in the art and have been developed for a variety of purposes. Presently, these applications are used across a variety of industries, allowing users to offer services on a personal basis, thereby avoiding the expenses associated with a traditional business. Typically, these applications are so-called “mobile apps” that users download to a mobile device, identifying themselves as either a provider or consumer of a service. Examples of transactions using such applications include ride share services, with the provider offering rides to the customer, food delivery services, wherein the provider procures and delivers food to the customer, and short-term home stay services, where a property owner provider offers a property for customers to rent in the manner of a hotel room.

One industry involving a provider/customer relationship where convenience is lacking is that of laundry services. Presently, businesses exist for washing, drying, and folding laundry. These businesses may be ancillary to a traditional dry-cleaning business, or may be solely dedicated to regular laundry. There are several drawbacks to conventional laundry service businesses. First, there are high start-up and operational costs to such a business. Procuring and maintaining equipment is expensive, and the rent, employment, and related general operational costs are passed on to consumers. In addition to the high fees charged for laundry services, there is a lack of convenience. Customers must collect their laundry and transport it to the business location where the equipment is housed. In some instances, the laundry may be picked up by the business, but this increases costs even more. Finally, there is a problem with scheduling laundry services to be expedited. Due to the uncertain nature of a business workload, a customer may have to wait several days to receive washed, cleaned, and folded laundry.

It is therefore an object of the present invention to provide an interactive app-based platform allowing customers needing laundry services to connect with individuals having in-home laundry facilities, and coordinate those individuals as service providers in providing laundry services for the customers. Another object of the invention is to use app-based location services to connect customers with service providers who are nearby and can perform cleaning operations quickly and effectively. Yet another object of the invention is to provide a standardized quantity of laundry to quantify the amount of laundry to be cleaned by the service provider and the cost for doing so. Yet another object of the invention is to provide a payment system, whereby a consumer can pay a service provider for laundry services in an efficient secure manner. These and other objects of the invention are more fully developed in the following summary, description, claims, and drawings.

### SUMMARY

A computer implemented method for providing user-based on-demand laundry services includes providing a peer-to-peer laundry service platform and configuring the platform to identify a plurality of client accounts and a plurality of service provider accounts. The platform detecting a user selecting either a client account or a service provider account, and detecting a notice of availability by at least one service provider account for laundry services. The method includes receiving a search query from the client account, the search query identifying a quantity of the laundry, and identifying a plurality of the available service provider accounts and selecting from among them a proximal service provider account.

The method further includes the platform reporting the search query to the proximal service provider account, receiving an acceptance command from the proximal service provider account, and reporting the acceptance command to the client account, detecting a completion signal, and processing a payment from the client account to the proximal service provider account. In some embodiments, the completion signal may be generated by the client account. In other embodiments, the completion signal may be generated by the proximal service provider account. Preferably, the quantity of the laundry is measured as a quantity of laundry containers, each laundry container having a uniform volume.

In other embodiments, the search query may include a deadline for the completion signal. Additionally, the search query may include an instruction selected from among pick-up instructions, detergent instructions, fabric softener instructions, colorant instructions, ironing instructions, folding instructions, and delivery instructions, either individually, collectively, and including among other instructions. Preferably, a delay notice may also be provided enabling the proximal service provider account to update the completion signal in the event of a delay. Additionally, the platform may configure the plurality of service provider accounts to include vehicle identifying information.

The invention may also be characterized as a system having a non-transitory computer readable medium with instructions encoded thereon, with one or more processors configured, when executing the instructions, to perform the operations of providing a peer-to-peer laundry service platform and configuring the platform to identify a plurality of client accounts and a plurality of service provider accounts. Detecting the selection of either a client account or a service provider account, and detecting a notice of availability by at least one service provider account for laundry services.

The one or more processors further configured for receiving a search query from the client account, the search query identifying a quantity of the laundry, identifying a plurality of the available service provider accounts and select from among them a proximal service provider account, reporting the search query to the proximal service provider account, receiving an acceptance command from the proximal service provider account and report the acceptance command to the client account, detecting a completion signal, and processing a payment from the client account to the proximal service provider account.

In other preferred embodiments the completion signal may be generated by the client account, or the completion signal may be generated by the proximal service provider account. Preferably, the quantity of the laundry is measured as a quantity of laundry containers, with each laundry container having a uniform volume. The search query may include a deadline for the completion signal. Additionally, the search query may include an instruction selected from the group consisting of pick-up instructions, detergent instructions, fabric softener instructions, colorant instructions, ironing instructions, folding instructions, and delivery instructions. In one preferred embodiment, a delay notice is provided enabling the proximal service provider account to update the completion signal. In another preferred embodiment, the plurality of service provider accounts may be configured to include vehicle identifying information.

In yet another implementation, the invention may be characterized as a computer program product comprising a non-transitory computer-readable storage medium containing computer program code, the computer program code when executed by one or more processors causes the one or more processors to perform operations, the computer program code comprising instructions to provide a peer-to-peer laundry service platform and configure the platform to identify a plurality of client accounts and a plurality of service provider accounts.

Other instructions include detecting the selection of either a client account or a service provider account, and detecting a notice of availability by at least one service provider account for laundry services. Additionally, receiving a search query from the client account, the search query identifying a quantity of the laundry, identifying a plurality of the available service provider accounts and selecting from among them a proximal service provider account, reporting the search query to the proximal service provider account, receiving an acceptance command from the proximal service provider account and report the acceptance command to the client account, detecting a completion signal, and processing a payment from the client account to the proximal service provider account. The completion signal may be generated by the client account, or generated by the proximal service provider account. The instructions may also be configured such that the quantity of the laundry is measured as a quantity of laundry containers, each laundry container having a uniform volume.

### BRIEF DESCRIPTION OF THE FIGURES

FIG. 1 is a system diagram of the system and method for on-demand laundry services.

FIG. 2 is a flowchart of an exemplary method for conducting a single instance of on-demand laundry services conducted using the system and method.

### DESCRIPTION

Three roles are defined for the on-demand laundry services system and method: a platform provider role, a service provider role, and a client role. The platform provider role is the host of the system, responsible for hosting the on-demand laundry service platform, including all servers and software required to execute the service, and all websites, apps, etc. required for peer-to-peer networking between the service providers and the clients. The service provider role is a user role defined by a capacity to execute laundry cleaning services. The service providers are responsible for offering and performing laundry cleaning operations including, optionally, pick-up and drop-off services according to client specifications. The client role is a user role defined by a need for laundry services (i.e., the “customer” role in a traditional laundry service interaction), and provides the details required for performing requested laundry services. The service providers and the clients comprise the two user types in the system, with the platform operating as a social network for providing peer-to-peer localized laundry services.

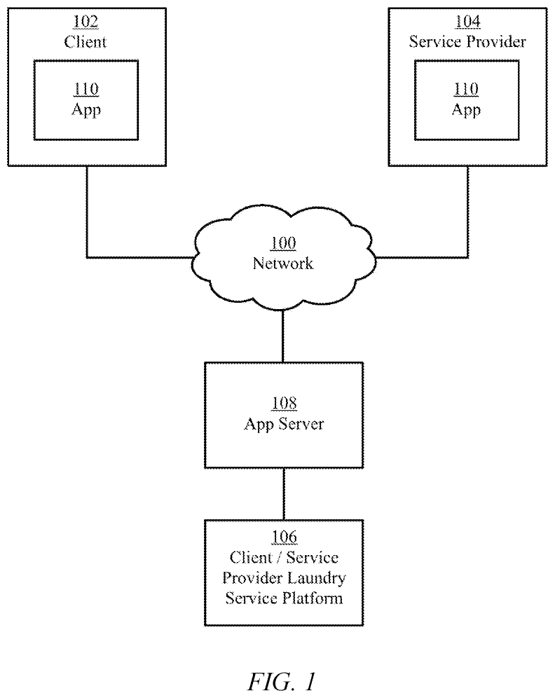

Referring to FIG. 1, an exemplary system architecture required for supporting a preferred embodiment is shown. The network 100 represents all communication pathways that may be required between the client (i.e., a client device 102), the service provider (i.e., a service provider device 104), and the client/service provider laundry service platform 106. In various exemplary embodiments, the network 100 may be the Internet, or may comprise private communication networks (for example, local area networks, wide area networks, etc.) that may or may not be connected to the Internet. The network 100 preferably uses standard communications protocols as are known in the art, and related standard technologies.

The application server 108 is a server that hosts applications or “apps” 110 on client devices 102 and on service provider devices 104. The app server 108 delivers data and content to the apps 110, thereby forming the basic interface for the clients and services providers to interact, and request, schedule, perform, and complete laundry services. In the context of this application, “data” is understood to include information about a client's location, the nature of the laundry services (quantity, timing, and other related variables), information about the service provider, and the like. For example, for information related to laundry services, the data can include information such as price, number of standardized laundry bags, special instructions regarding soaps, fragrances, etc., pick up time, and drop off time, etc. Also, for information about a service provider, data can include background information such as identity, location, vehicle description, reviews, and other information relevant to a client's selection of a service provider.

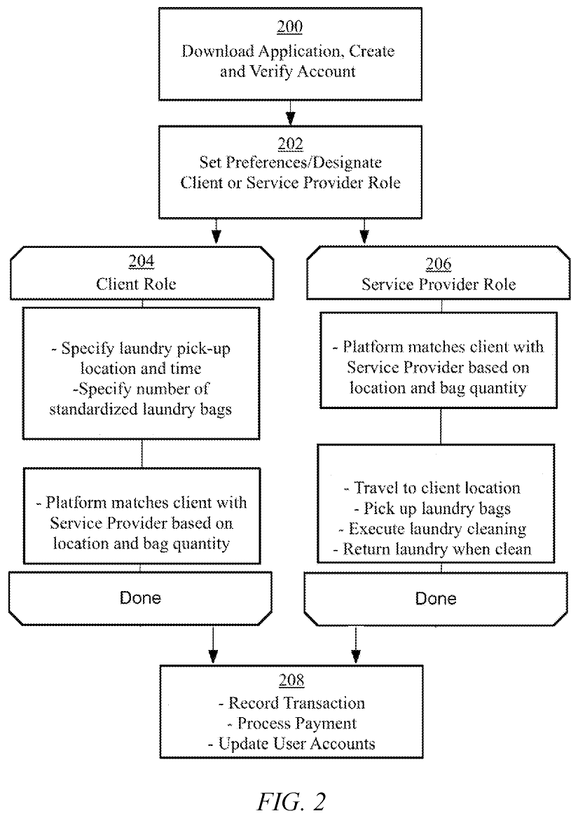

Referring to FIG. 2, in one preferred embodiment, the system and process for providing on-demand laundry services may comprise at least the following elements, which constitute steps executed within the platform and provided through the network, among others. These include related steps executed by users in the client role for soliciting laundry services, and steps executed by users in the service provider role for offering laundry services (and ancillary services such as optional folding, packaging, and delivery services.) The platform service steps include actions taken by both the client user role and a service provider user role.

In the illustrated embodiment, a non-exhaustive list of these actions includes step 200 wherein each user (in the roles of both clients and service providers) download the on-demand laundry service app 110 (FIG. 1) to a computing apparatus, preferably a mobile computing apparatus, create an account, including identifying a username and the user's identity, and verify the account, for example, using two-factor verification or similar security process. In step 202, specific user preferences are set up, including designating an account as either a client 102 (FIG. 1) in the client role 204 or a service provider 104 (FIG. 1) in the service provider role 206. In some embodiments, it may be possible for the app 110 to designate two roles to a single account, and allow the user to select between client and service provider roles.

Still referring to FIG. 2, the selected role type will govern subsequent actions taken by clients and services providers in the app 110 (FIG. 1). When a user sets the app 110 for the client role 204, and needs laundry service, the client first collects a quantity of laundry and places the laundry in one or more laundry bags dedicated for the app. Preferably the laundry bags are of a predetermined size, and are volumetrically equal, allowing a laundry cleaning task to be quantified by the number of bags for which cleaning is requested. In one embodiment, twenty five pound bags are contemplated. In various alternative embodiments, sets of different types and sizes of laundry bags may be provided, allowing users to divide laundry up according to garment type, color, etc., each billed per bag. In other embodiments, standardized bags corresponding to a particular weight may be employed. Preferably, a user in the client role 204 is responsible for ensuring each paid-for laundry bag is fully packed to maximize bag capacity.

After the client role 204 user launches the application, the user specifies a laundry pick up location and time, and specifies a predetermined quantity of laundry bags to be picked up for service. The laundry collection location may be automatically provided by a location services feature on the user's device 102 (FIG. 1), or may be provided directly by the user in a client role 204. Thereafter the platform will match the client role 204 with a user in a service provider role 206, preferably according to the most efficient pairing in terms of location and bag quantity. In some embodiments, this may be the most efficient in terms of distance and speed.

When the app is set for the service provider role 206, the platform matches a client to the service provider. In one preferred embodiment, the platform matches the client to a service provider based on location. For example, giving preference to the service provider in the closest proximity to the client requesting service based on location data for both parties. Alternatively, the platform may match a client to a service provider using another factor. For example, factors including time preferences of the users, or profile identifying information may be bases for connecting clients to service providers. Once a service provider has been selected by the platform, the platform alerts the service provider who may accept the client's request for laundry services.

The service provider role 206 further designates that the service provider will travel to a designated client location in a vehicle (or vehicles) preferably registered with the system at the time of account registration, pick up a predetermined number (and/or type) of laundry bags, and perform laundry services (including at least one of washing, drying, and/or folding laundry). This typically involves the service provider traveling back to the service provider's location. Alternatively, the service provider may use a third party laundry facility. After performing laundry services, the service provider will deliver completed laundry to a client's registered address in the same vehicle used for collecting the laundry at the start of the service provider's contracted services.

Once the client role 204 and the service provider role 206 for a single transaction are executed, the platform takes the final step 208 of recording the transaction as complete, processes a payment from the client to the service provider and updates their respective user accounts accordingly. In various alternative embodiments, the platform may provide a dispute resolution function and/or provide a forum for reviews among other features.

In various alternative embodiments, the platform 106 may include functionality for selecting on-demand laundry services including wash, dry, and fold services. In other embodiments specialty cleaning services, such as dry cleaning services, may be included. Additionally, the platform may provide a functionality for clients and service providers to select among a number of cleaning, fabric softening, and related products. In one embodiment, the platform 106 provides the service provider role 206 with the ability to enter a pre-determined list of cleaning, fabric softening, and related products, among which a user in the client role 204 may select. In another embodiment, the platform 106 provides the client role 204 with the ability to identify any known allergies to specific laundry detergents, softeners, coloring agents, etc.

In various alternative embodiments, the platform 106 may include functionality allowing users in a service provider role 206 to input status updates which are retrievable by a user in the client role 204 while laundry services are being performed. This may include a completion time/date estimate, and may include the ability for users in a service provider 206 role to update the completion estimate as conditions affecting the completion time change.

In various alternative embodiments, the platform 106 may provide location information to users in the client role 204 and the service provider role 206 which enables door-to-door pick-up and delivery. Alternatively, a remote location, such as a drop box, kiosk, or other secure container may be provided for client role 204 drop-off and service provider role 206 pick-up and delivery. Preferably no third parties are needed, with the platform 106 providing all actions (client/service provider matching, location coordination, and payment) with no outside input.

In various alternative embodiments, the platform 106 may provide a scheduling option enabling a user in the client role 206 to arrange for a user in the service provider role 206 to pick up laundry for service in the future. Alternatively, the platform 106 may include an “on-demand” functionality, wherein a user in the client role 204 is alerted that a user in the service provider role 206—including a list of those that are within a predefined range or distance—is currently available, thereby enabling the client to expedite laundry services, when necessary, on a “same day” basis.

The features and advantages described in the specification are not all-inclusive. Many additional features and advantages will be apparent to one of ordinary skill in the art in view of the drawings, specification, and claims. Moreover, the language used in the specification has been principally selected for readability and instructional purposes. and may not have been selected to delineate or circumscribe the inventive subject matter. The foregoing description of embodiments of the invention was presented for the purpose of illustration, and is not exhaustive or limiting to the precise forms disclosed. Persons skilled in the relevant art can appreciate that many modifications and variations are possible.

Any of the steps, operations, or processes described herein may be performed or implemented with one or more hardware or software modules, alone or in combination with other devices In one embodiment, a software module is implemented with a computer program product comprising a computer-readable medium containing computer program code, which can be executed by a computer processor for performing any or all steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of niedia suitable for storing electronic; instructions, and coupled to a computer system bus. Furthermore, any computing systems referred to in the specification may include a single processor or may be architectures employing multiple processor designs for increased computing capability.

Finally, it is intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer implemented method for providing user-based on-demand laundry services, the method comprising:
providing a peer-to-peer laundry service platform and configuring the platform to identify a plurality of client accounts and a plurality of service provider accounts;
detecting the user selecting either a client account or a service provider account, and detecting a notice of availability by at least one service provider account for laundry services;
receiving a search query from the client account, the search query identifying a quantity of the laundry;
identifying a plurality of the available service provider accounts and selecting from among them a proximal service provider account;
reporting the search query to the proximal service provider account;
receiving an acceptance command from the proximal service provider account and reporting the acceptance command to the client account;
detecting a completion signal; and
processing a payment from the client account to the proximal service provider account.

2. The method of claim 1 wherein the completion signal is generated by the client account.

3. The method of claim 1 wherein the completion signal is generated by the proximal service provider account.

4. The method of claim 1 wherein the quantity of the laundry is measured as a quantity of laundry containers, each laundry container having a uniform volume.

5. The method of claim 1 wherein the search query includes a deadline for the completion signal.

6. The method of claim 1 wherein the search query includes an instruction selected from the group consisting of pick-up instructions, detergent instructions, fabric softener instructions, colorant instructions, ironing instructions, folding instructions, and delivery instructions

7. The method of claim 1 further comprising providing a delay notice enabling the proximal service provider account to update the completion signal.

8. The method of claim 1 further comprising the step of configuring the plurality of service provider accounts to include vehicle identifying information.

9. A system comprising:
a non-transitory computer readable medium with instructions encoded thereon; and
one or more processors configured to, when executing the instructions, perform operations of:
provide a peer-to-peer laundry service platform and configure the platform to identify a plurality of client accounts and a plurality of service provider accounts;
detect the selection of either a client account or a service provider account, and detect a notice of availability by at least one service provider account for laundry services;
receive a search query from the client account, the search query identifying a quantity of the laundry;
identify a plurality of the available service provider accounts and select from among them a proximal service provider account;
report the search query to the proximal service provider account;
receive an acceptance command from the proximal service provider account and report the acceptance command to the client account;
detect a completion signal; and
process a payment from the client account to the proximal service provider account.

10. The method of claim 9 wherein the completion signal is generated by the client account.

11. The method of claim 9 wherein the completion signal is generated by the proximal service provider account.

12. The method of claim 9 wherein the quantity of the laundry is measured as a quantity of laundry containers, each laundry container having a uniform volume.

13. The method of claim 9 wherein the search query includes a deadline for the completion signal.

14. The method of claim 9 wherein the search query includes an instruction selected from the group consisting of pick-up instructions, detergent instructions, fabric softener instructions, colorant instructions, ironing instructions, folding instructions, and delivery instructions

15. The method of claim 9 further comprising providing a delay notice enabling the proximal service provider account to update the completion signal.

16. The method of claim 9 further comprising the plurality of service provider accounts configured to include vehicle identifying information.

17. A computer program product comprising a non-transitory computer-readable storage medium containing computer program code, the computer program code when executed by one or more processors causes the one or more processors to perform operations, the computer program code comprising instructions to:
provide a peer-to-peer laundry service platform and configure the platform to identify a plurality of client accounts and a plurality of service provider accounts;
detect the selection of either a client account or a service provider account, and detect a notice of availability by at least one service provider account for laundry services;
receive a search query from the client account, the search query identifying a quantity of the laundry;
identify a plurality of the available service provider accounts and select from among them a proximal service provider account;
report the search query to the proximal service provider account;
receive an acceptance command from the proximal service provider account and report the acceptance command to the client account;
detect a completion signal; and
process a payment from the client account to the proximal service provider account.

18. The method of claim 17 wherein the completion signal is generated by the client account.

19. The method of claim 17 wherein the completion signal is generated by the proximal service provider account.

20. The method of claim 17 wherein the quantity of the laundry is measured as a quantity of laundry containers, each laundry container having a uniform volume.
